(19) United States
(12) Patent Application Publication
(10) Pub. No.: US 2023/0034308 A1
(43) Pub. Date: Feb. 2, 2023

(54) AGRICULTURAL MANAGEMENT SYSTEM AND METHODS

(71) Applicant: CNH Industrial America LLC, New Holland, PA (US)

(72) Inventors: Peter Charles Caddick, Lancaster, PA (US); Simon Alexander Francis Nichol, Mohnton, PA (US)

(21) Appl. No.: 17/387,418

(22) Filed: Jul. 28, 2021

(51) Int. Cl. G06Q 50/02; G06Q 10/06; G07C 5/08; A01F 15/08

(52) U.S. Cl. CPC G06Q 50/02; G06Q 10/06315; G07C 5/0841; A01F 15/08

(57) ABSTRACT

A management system for a baling operation includes a vehicle configured to form one or more bales of agricultural material. A computing system is configured to determine bale data including at least a number of bales produced by the vehicle, receive, from one or more sensors, vehicle data related to operation of the vehicle as the one or more bales are formed, and store the vehicle data. An electronic device is communicatively coupled with the computing system and is configured to receive the number of bales produced by the vehicle, receive the vehicle data related to the operation of the vehicle as the one or more bales are formed, and generate one or more bale characteristics based on the number of bales and the vehicle data related to the operation of the vehicle as the one or more bales are formed.

### FIELD

The present disclosure generally relates to a baling system and, more particularly, to systems and methods for performing a bale collection operation in a more effective and/or efficient manner.

### BACKGROUND

In the field of agricultural operations, a baler may be towed behind a work vehicle (e.g., a tractor) when performing a baling operation. For example, following a prior harvesting operation, cutting operation, or windrowing operation, crop material can be deposited within a field in swaths or windrows. Thereafter, the baler may be towed across the field to collect the crop material and produce bales. For instance, the baler may collect the crop material via an intake or collection device located at the front of the baler and deliver such crop material to a baling chamber of the baler, within which the crop material is compacted into a bale of a predetermined shape (e.g., a round bale or a square/rectangular bale). In some instances, the resulting bale is then ejected from the rear of the baler and deposited within the field.

Following the performance of a baling operation, the bales deposited within the field are collected. For instance, an operator manually drives a work vehicle to collect the various bales individually and transport each bale to a desired location. Unfortunately, given the baling process, bales are often scattered across the field randomly and a harvested number of bales from a field may be unknown until collected, which may occur once the bale is purchased. As such, insight into the cost to produce such bale may be vague. Accordingly, systems and methods for collecting the efficiency of performing the associated bale collection operation would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a management system for a baling operation. The system includes a vehicle configured to form one or more bales of agricultural material. A computing system is provided in operative association with the vehicle. The computing system is configured to determine bale data including at least a number of bales produced by the vehicle and receive, from one or more sensors, vehicle data related to operation of the vehicle as the one or more bales are formed. An electronic device is communicatively coupled with the computing system. The electronic device is configured to receive the number of bales produced by the vehicle; receive the vehicle data related to the operation of the vehicle as the one or more bales are formed; and generate one or more bale characteristics based on the number of bales produced by the vehicle and the vehicle data related to the operation of the vehicle as the one or more bales are formed.

In some aspects, the present subject matter is directed to a method for performing a baling operation. The method includes receiving, from a computing system, a number of bales produced by a vehicle configured to form one or more bales of agricultural material. The method also includes receiving, from the computing system, vehicle data related to operation of the vehicle as the number of bales formed. Further, the method includes generating, through an electronic device, one or more bale characteristics based on the number of bales produced by the vehicle and the vehicle data related to the operation of the vehicle as the one or more bales are formed. Lastly, the method includes displaying the one or more bale characteristics on a display of the electronic device.

In some aspects, the present subject matter is directed to a management system for a baling operation. The system includes a computing system provided in operative association with a vehicle, the computing system configured to determine a number of bales produced by the vehicle, receive vehicle data related to operation of the vehicle as one or more bales are formed. An electronic device is communicatively coupled with the computing system and is configured to receive the number of bales and the vehicle data from the computing system; receive, through a user interface of the electronic device, an input related to a cost per bale; and generate an invoice. The invoice is transmitted to a computing device. The computing system, the electronic device, and the computing device are remote from one another.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of a work vehicle towing a baler in accordance with aspects of the present subject matter;

FIG. 2 illustrates a simplified view of a field within which a baling operation is being performed in accordance with aspects of the present subject matter;

FIG. 3 illustrates a schematic of a management system for a bale operation in accordance with aspects of the present subject matter;

FIG. 4 is a block diagram illustrating a plurality of electronic devices operably coupled with a remote server in accordance with aspects of the present subject matter;

FIG. 5 illustrates a flow diagram of a method for performing a baling operation with a management system in accordance with aspects of the present subject matter; and

FIG. 6 illustrates a flow diagram of a method for performing a baling operation with a management system in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with some embodiments to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a management system for a baling operation. The system can include a work vehicle configured to form one or more bales of agricultural material. A computing system can be provided in operative association with the work vehicle. The computing system can be configured to determine bale data, such as a number of bales produced, a size of bales being collected (e.g., 4×5, 5×5, or 5×6), number of wraps of net, moisture (provided the baler is equipped with moisture sensor), density setting, and/or whether cutting tools of the baler are engaged or disengaged) and/or any other relevant data, as the bale is produced by the work vehicle.

In addition, the computing system may be configured to receive vehicle data related to operation of the work vehicle as the one or more bales are formed, from one or more sensors. The vehicle data can be related to the operation of the work vehicle includes at least one of a distance traveled during the baling operation, an amount of fuel consumed during the baling operation, an amount of wear to one or more components of the work vehicle, or an amount of time for the baling operation, and/or any other relevant data.

An electronic device can be communicatively coupled with the computing system. The electronic device may be configured to receive the bale data and the vehicle data related from the computing system. In turn, the electronic device may generate one or more bale characteristics based on the bale data and the vehicle data. In some instances, the one or more bale characteristics includes an estimated cost per bale based on the number of bales and an estimated cost of operation of the work vehicle. Additionally or alternatively, the bale characteristics may include a cost per weight of an agricultural product, cost per cubic inch of agricultural product within the bale, etc.

In some instances, the computing system and/or the electronic device may then utilize the bale characteristics to display or otherwise provide the one or more bale characteristics to a user of the management system. In response, the management system may receive an input related to a desired margin (e.g., profit margin) and generate a suggested bale price based on the estimated cost per bale and the desired margin. Additionally or alternatively, the management system may further be configured to receive an input related to a sold number of bales. In response, the management system may generate an invoice based on the sold number of bales. The invoice may then be transmitted or provided to a remote computing device. As used herein, any device is remote from another when each of the two devices may be used in two separate locations.

In some embodiments, the management system may be used for one or more vehicles that may be contracted to harvest the agricultural product. For instance, the management system may store the number of bales produced during the baling operation and vehicle data related to operation of the vehicle as the one or more bales are formed. Additionally or alternatively, the management system may be communicatively coupled with a remote server that may provide additional data related to the baling operation. Based on the vehicle data and the additional data provided by the remote server, the management system may be capable of determining an estimated cost to produce each bale. In turn, the management system may generate a profit margin based on the number of bales and the estimated cost to produce each bale.

In various embodiments of the present subject matter, the management system may receive data and information from various sources to generate a bale characteristic. The bale characteristics may provide additional insight and financial advantages to a vehicle operator and/or a vehicle owner.

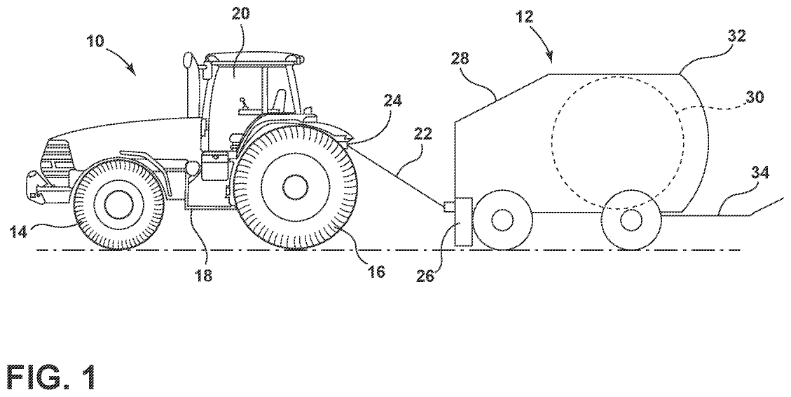

Referring now to the drawings, FIG. 1 illustrates a side view of a work vehicle 10 towing a baler 12 in accordance with aspects of the present subject matter to perform a baling operation within a field. As shown, the work vehicle 10 is configured as an agricultural tractor, such as an operator-driven tractor or an autonomous tractor. However, in other embodiments, the work vehicle 10 may correspond to any other suitable vehicle configured to tow a baler 12 across a field or that is otherwise configured to facilitate the performance of a baling operation, including an autonomous baling vehicle. Additionally, as shown, the baler 12 is configured as a round baler configured to generate round bales. However, in other embodiments, the baler 12 may have any other suitable configuration, including being configured to generate square or rectangular bales.

As shown in FIG. 1, the work vehicle 10 includes a pair of front wheels 14, a pair of rear wheels 16, and a chassis 18 coupled to and supported by the wheels 14, 16. An operator's cab 20 may be supported by a portion of the chassis 18 and may house various input devices for permitting an operator to control the operation of the work vehicle 10 and/or the baler 12. Additionally, the work vehicle 10 may include an engine and a transmission mounted on the chassis 18. The transmission may be operably coupled to the engine and may provide variably adjusted gear ratios for transferring engine power to the wheels 16 via a drive axle assembly.

As schematically shown in FIG. 1, the work vehicle 10 may be coupled to the baler 12 via a tongue 22 mounted on a hitch 24 of the work vehicle 10 to allow the vehicle 10 to tow the baler 12 across the field. As such, the work vehicle 10 may, for example, guide the baler 12 toward crop material deposited in windrows on the field. As is generally understood, to collect the crop material, the baler 12 includes a crop collector 26 (shown schematically in FIG. 1) mounted on the front end of the baler 12. The crop collector 26 may, for example, have a rotating wheel that collects crop material from the ground and directs the crop material toward a bale chamber 28 of the baler 12. Inside the bale chamber 28, rollers, belts, and/or other devices compact the crop material to form a generally cylindrically shaped bale 30. The bale 30 is contained within the baler 12 until ejection of the bale 30 is instructed (e.g., by the operator). In other embodiments, the bale 30 may be automatically ejected from the baler 12 once the bale 30 is formed.

In various instances, prior to or after ejection of the bale 30 from the baler 12, a retaining structure may be positioned about at least a portion of the bale 30. The retaining structure may assist in maintaining the bale 30 in a predefined shape. In some examples, the retaining structure may be configured as a netting, a twine, a string, and/or any other structure.

As shown in FIG. 1, the baler 12 may also include a tailgate 32 movable between a closed position (as shown in the illustrated embodiment) and an opened position via a suitable actuator assembly. In the closed position, the tailgate 32 may confine or retain the bale 30 within the baler 12. In the open position, the tailgate 32 may rotate out of the way to allow the bale 30 to be ejected from the bale chamber 28. Additionally, as shown in FIG. 1, the baler 12 may include a ramp 34 extending from its aft end that is configured to receive and direct the bale 30 away from the baler 12 as it is being ejected from the bale chamber 28. In some embodiments, the ramp 34 may be spring-loaded, such that the ramp 34 is urged into a raised position, as illustrated. In such an embodiment, the weight of the bale 30 on the ramp 34 may drive the ramp 34 to a lowered position in which the ramp 34 directs the bale 30 to the soil surface. Once the bale 30 is ejected, the bale 30 may roll down the ramp 34 and be deposited onto the field. As such, the ramp 34 may enable the bale 30 to maintain its shape and desired density by gently guiding the bale 30 onto the field.

It will be appreciated that the configuration of the work vehicle 10 described above and shown in FIG. 1 is provided only to place the present subject matter in an exemplary field of use. Thus, it will be appreciated that the present subject matter may be readily adaptable to any manner of work vehicle configuration. For example, in other embodiments, a separate frame or chassis may be provided to which the engine, transmission, and drive axle assembly are coupled, a configuration common in smaller tractors. Still other configurations may use an articulated chassis to steer the work vehicle 10, or rely on tracks in lieu of the wheels 14, 16. Additionally, as indicated above, the work vehicle 10 may, in other embodiments, be configured as an autonomous vehicle. In such embodiments, the work vehicle 10 may include suitable components for providing autonomous vehicle operation and, depending on the vehicle configuration, need not include the operator's cab 20.

Additionally, it will be appreciated that the configuration of the baler 12 described above and shown in FIG. 1 is provided only to place the present subject matter in an exemplary field of use. Thus, it will be appreciated that the present subject matter may be readily adaptable to any manner of baler configuration. For example, as indicated above, the baler 12 may, in alternative embodiments, correspond to a square baler configured to generate square or rectangular bales. Additionally or alternatively, the baler 12 may deposit the bale 30 onto a structure in addition to or in lieu of placing the bales within the field. For instance, the bales may be moved from the baler 12 to a trailer or wagon that is proximate to the baler 12.

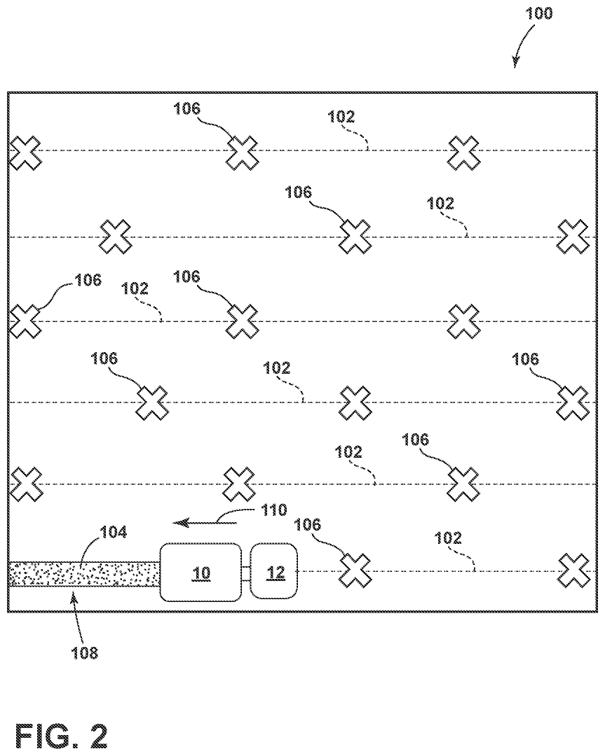

Referring now to FIG. 2, a simplified, top-down view of a field 100 in which a baling operation is being performed is illustrated in accordance with aspects of the present subject matter. In general, the baling operation will be described as being performed by the vehicle 10 and/or the baler 12 described above with reference to FIG. 1. However, it will be appreciated that the baling operation may generally be performed using any suitable vehicle having any other suitable vehicle configuration and/or any other baler have any other suitable baler configuration.

As shown, the work vehicle 10 may be configured to tow the baler 12 across the field 100 along a plurality of baling paths (indicated by dashed lines 102 in FIG. 2) to collect agricultural product 104 from the field 100 and generate bales 106 (with each bale 106 deposited within the field 100 being indicated by an “X” in FIG. 2). In some embodiments, the baling paths 102 may be aligned with or defined relative to the location of agricultural product 104 previously deposited within the field 100 along a plurality of spaced-apart windrows 108 (e.g., via a windrower). In such an embodiment, each baling path 102 may, for example, be substantially aligned with a centerline of a corresponding windrow 108. However, in other embodiments, the baling paths 102 may be defined across the field 100 in any other suitable manner that allows agricultural product 104 to be collected from the field 100 and subsequently baled. Additionally, it will be appreciated that, although the illustrated embodiment depicts straight or non-curved baling paths 102 extending across the field 100 in a given direction, the baling paths 102 may, instead, correspond to curved bailing paths and/or may extend across the field 100 in any other suitable direction.

As the tractor 10 tows the baler 12 across the field 100 along each baling path 102, the collected agricultural product 104 is baled within the baler 12 and subsequently ejected therefrom back into the field as a bale 106. As such, one or more bales 106 may be deposited along each baling path 102 as the vehicle 10 and/or the baler 12 make a given baling pass across the field 100. In this regard, it will be appreciated that the specific number of bales 106 deposited along each baling path 102 may generally vary based on, for example, the length of the baling path 102 across the field 100, the amount of agricultural product 104 to be collected along the baling path 102, and/or the desired size of each bale 106. Thus, although FIG. 2 shows three bales 106 deposited along each baling path 102, any other suitable number of bales 106 may be deposited along each baling path 102 during the performance of the baling operation, such as less than three bales 106 (e.g., two bales, one bale, or even zero bales) or greater than three bales 106 (e.g., four bales, five bales, or more).

Additionally, in several embodiments, various types of data may be collected as the baling operation is being performed within the field 100. For example, in some embodiments, the work vehicle 10 and/or the baler 12 may be provided with a positioning device (e.g., a GPS device) that tracks the location of the vehicle 10 and/or the baler 12 as it is moved across the field 100. In such an embodiment, position data may be collected during the baling operation (e.g., by being recorded or stored within the memory of an on-board computer of the vehicle 10 and/or the baler 12) that is associated with the location/coordinates of each baling path 102 across the field 100.

In addition to collecting data associated with the position/coordinates of the baling paths 102, data may also be collected/recorded that is associated with the specific position/coordinates of each bale 106 within the field 100. For instance, in some embodiments, for each bale 106 deposited within the field 100, a set of GPS coordinates may be recorded that corresponds to the exact location of such deposited bale 106 within the field 100. As a result, upon completion of the baling operation, a database of bale position data may be available that specifies the various positions of the bales 106 within the field 100.

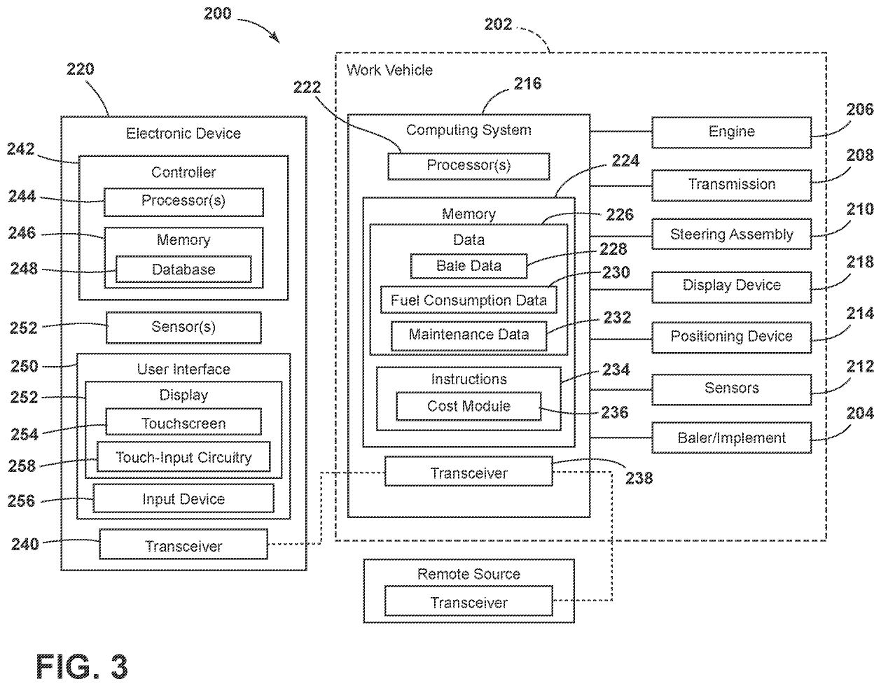

Referring now to FIG. 3, a schematic view of some embodiments of a management system 200 for monitoring a baling operation is illustrated in accordance with aspects of the present subject matter. In general, the management system 200 will be described herein with reference to the work vehicle 10 and the baler 12 described above with reference to FIG. 1. However, it will be appreciated that the disclosed management system 200 may generally be utilized with work vehicles having any suitable vehicle configuration and/or balers have any suitable baler configuration. Additionally, for purposes of providing an illustrative example of a bale collection operation, the management system 200 will generally be described herein with reference to the performance of the example baling operation described above with reference to FIG. 2. It will be appreciated that the disclosed management system 200 may generally be utilized to perform any suitable baling operation within any suitable field. Additionally, the disclosed management system 200 may generally be utilized to perform any other suitable agricultural operation in conjunction with or independently of the baling operation.

In several embodiments, the management system 200 may include a work vehicle 202 configured to form bales within a field 100 (FIG. 2) with a baler 204. In some embodiments, the work vehicle 202 may correspond to the vehicle 10 described above with reference to FIGS. 1 and 2. Likewise, in some embodiments, the baler 204 may correspond to the baler 12 described above with reference to FIGS. 1 and 2. Upon completion of the baling operation, the baler 12 may be unhitched from the vehicle 202 and a suitable bale pick-up device or another implement (e.g., a bale spear) may be installed on the vehicle 202 to allow for the collection of bales from the field. In some embodiments, the work vehicle 202 may correspond to any other suitable vehicle that can be used to collect bales standing within the field, including any suitable autonomous vehicle and/or any suitable operator-driven vehicle (e.g., a skid-steer loader). The bales, once collected, may be distributed to one or more customers and/or maintained within the field.

As shown in FIG. 3, the work vehicle 202 may include various components for allowing the vehicle 202 to be moved across the field during the bale collection operation. For example, the work vehicle 202 may include an engine 206 and a transmission 208 coupled to the engine 206 for propelling the vehicle 202 through the field. In addition, the work vehicle 202 may include a steering assembly 210 for steering the work vehicle 202. In some embodiments, the steering assembly 210 may be configured to be manually operated via the operator to steer the vehicle 202. Alternatively, the steering assembly 210 may be configured to be automatically controlled to allow the work vehicle 202 to be directed along a predetermined path(s) across the field. For example, in some embodiments, the steering assembly 210 may include or form part of an auto-guidance system for automatically steering the work vehicle 202. In such an embodiment, the work vehicle 202 may correspond to a fully autonomous vehicle, a semi-autonomy vehicle, or an otherwise manually operated vehicle having one or more autonomous functions (e.g., automated steering or auto-guidance functions).

Further, as provided herein, a baler 204 may be operably coupled with the vehicle 202 (e.g., through a hitch assembly). Additionally or alternatively, the baler 204 may be implemented within the vehicle 202 without departing from the scope of the present disclosure. As the vehicle 202 moves the baler 204 across the field 100 (FIG. 2), the collected agricultural product 104 (FIG. 2) is baled within the baler 204 and subsequently ejected therefrom back into the field as a bale 106 (FIG. 2).

In several embodiments, various types of data may be collected from one or more sensors 212 as the baling operation, or other operations, is performed within the field 100. The one or more sensors 212 may be configured to detect any operational condition of the vehicle 202 and/or the baler 204. For example, the one or more sensors 212 may be configured to detect a distance traveled during baling, a number of bales per acre, a fuel usage, a usage of any component of the vehicle, a failure of any component of the vehicle, an amount of time the vehicle is used during the baling operation, etc.

In some embodiments, the work vehicle 202 and/or the baler 204 may be provided with a positioning device 214 (e.g., a GPS device) that tracks the location of the vehicle 202 and/or the baler 204 as it is moved across the field 100. For example, in some embodiments, the positioning device 214 may be configured to determine the exact location of the work vehicle 202 using a satellite navigation position system (e.g. a GPS system, a Galileo positioning system, the Global Navigation satellite system (GLONASS), the BeiDou Satellite Navigation and Positioning system, and/or the like). In such an embodiment, position data may be collected during the baling operation (e.g., by being recorded or stored within the memory 224 of an on-board computer of the vehicle 202 and/or the baler 204) that is associated with the location/coordinates of each baling path 102 across the field 100.

As shown in FIG. 3, the management system 200 may also include a computing system 216. In some embodiments, the computing system 216 may be communicatively coupled to one or more components of the work vehicle 202 (e.g., the engine 206, the transmission 208, and/or the steering assembly 210) for electronically controlling the operation of such component(s) (e.g. electronic control based on inputs received from the operator and/or automatic electronic control for executing one or more autonomous control functions). As will be described in greater detail below, the computing system 216 may, in several embodiments, be configured to generate various bale characteristics based on detected conditions of the vehicle 202 and/or the baler 204. Additionally or alternatively, the computing system 216 may, in various embodiments, be configured to generate various bale characteristics based on inputs received related to the baling operation. For example, the computing system 216 may be configured to generate an estimated cost per bale based, at least in part, on data associated with the baling operation (e.g., the distance traveled during baling, the number of bales per acre, the fuel usage, etc.). Further, costs of various supplies and/or maintenance costs may be inputted into the computing system 216, which may be used in conjunction with or in lieu of sensed data to generate an estimated cost per bale based, at least in part, on data associated with the baling operation (e.g., the distance traveled during baling, the number of bales per acre, the fuel usage, etc.).

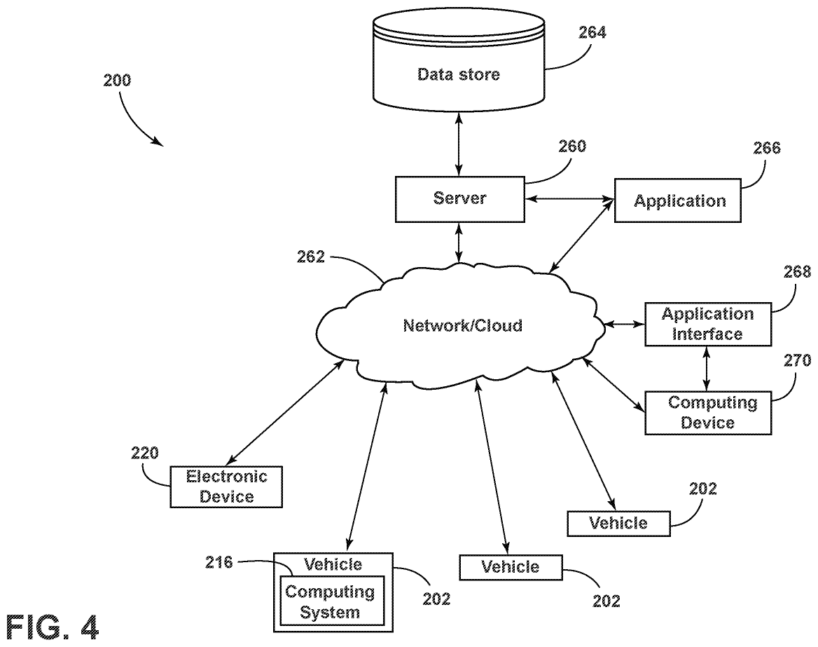

The computing system 216 and/or the electronic device 220 may then utilize the bale data and/or the vehicle data to display or otherwise provide the one or more bale characteristics to a user of the management system 200 through a user interface 250 or any other device. In response, the management system 200 may receive an input related to a desired margin (e.g., profit margin) and generate a suggested bale price based on the estimated cost per bale and the desired margin. Additionally or alternatively, the management system 200 may further be configured to receive an input related to a sold number of bales. In response, the management system 200 may generate an invoice based on the sold number of bales. The invoice may then be transmitted or provided to a remote computing device 270 (FIG. 4).

In some embodiments, the management system 200 may be used for one or more vehicles that may be contracted to harvest the agricultural product. For instance, the management system 200 may store the number of bales produced during the baling operation and vehicle data related to operation of the vehicle 202 as the one or more bales are formed. Additionally or alternatively, the management system 200 may be communicatively coupled with a remote server 260 that may provide additional data related to the baling operation. Based on the vehicle data and the additional data provided by the remote server 260, the management system 200 may be capable of determining an estimated cost to produce each bale. In turn, the management system 200 may generate a profit margin based on the number of bales and the estimated cost to produce each bale.

In general, the computing system 216 may correspond to any suitable processor-based device(s), such as a computing device or any combination of computing devices. Thus, as shown in FIG. 3, the computing system 216 may generally include one or more processor(s) 222 and associated memory devices 224 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 224 may generally comprise memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 224 may generally be configured to store information accessible to the processor(s) 222, including data 226 that can be retrieved, manipulated, created, and/or stored by the processor(s) 222 and instructions 234 that can be executed by the processor(s) 222.

In several embodiments, the data 226 may be stored in one or more databases. For example, the memory 224 may include a bale database 228 for storing data associated with the bales formed during the performance of the baling operation. Such data may, for instance, include any data collected during the performance of the baling operation, such as bale data (e.g., the position data associated with the location of the baling paths relative to the field, the heading data associated with the heading of the vehicle 202 and/or the baler 204 along each baling path, and/or the position data associated with the specific location of each bale within the field). In addition, various other types of data may be stored within the bale database 228. For example, in some embodiments, data may be stored within the bale database 228 that is associated with one or more operator inputs, one or more user-defined system preferences, and/or other system inputs relevant to one or more aspects of the present subject matter, such as data associated with the specific type of bales being collected (e.g., round bales vs. square/rectangular bales), data associated with the specific size of bales being collected (e.g., 4×5, 5×5, or 5×6), data associated with a desired or selected location for the staging area at which the bales will be aggregated, data associated with a desired spacing or arrangement of the collected bales within the staging area, and/or any other relevant data.

Additionally, as shown in FIG. 3, the memory 224 may also include one or more vehicle databases having data that relates to the use of one or more vehicles 202 and/or the baler 204. For example, the memory 224 may include a fuel consumption database 230 for storing data associated with fuel consumption of the work vehicle 202 during the performance of the bale operation and/or any previous agricultural operation. For example, as indicated above, the computing system 216 may be configured to generate an estimated cost of producing each bale. As such, the fuel consumption database 230 may, for example, include data associated with the amount of fuel used during the baling operation, during previously performed agricultural operations, and/or in predicted operations, such as bale collection operations. Based on the operations, a total amount of fuel may be calculated.

Further, as shown in FIG. 3, the memory 224 may also include a maintenance database 232 for storing data associated with maintenance of the work vehicle 202 and the baler 204 during the performance of the bale operation. In addition, the maintenance database 232 may also store any information related to other vehicles 202 that performed any previous agricultural operation. For example, as indicated above, the computing system 216 may be configured to generate an estimated cost of producing each bale. As such, the maintenance database 232 may, for example, include data associated with the maintenance costs for vehicles 202 used during the baling operation, during previously performed agricultural operations, and/or in predicted operations, such as bale collection operations. Based on the operations, a total maintenance cost may be calculated.

Referring still to FIG. 3, in several embodiments, the instructions 234 stored within the memory 224 of the computing system 216 may be executed by the processor(s) 222 to implement a cost module 236. In general, the cost module 236 may be configured to generate one or more bale characteristics based on the bale data and the vehicle data related to the operation of the work vehicle 202 as the one or more bales are formed, which may be stored within the fuel consumption database 230, the maintenance database 232, and/or any other database. Specifically, in several embodiments, the cost module 236 may be configured to aggregate the total cost to produce the one or more bales, which may then be related to the bale characteristics to determine a cost, profit margin, etc. of each bale.

In other embodiments, the cost module 236 may be configured to determine a profit for completing a baling operation. For instance, a user may be contracted to bale an agricultural product and be paid on a per bale basis. As such, the management system 200 may collect various data to determine the cost to produce each bale to generate a profit, a profit per bale, etc. of the baling operation. In addition, the cost module 236 may be configured to generate any other metric based on the operation of the vehicle 202 and the production of the bales.

With further reference to FIG. 3, in some examples, the computing system 216 may communicate via wired and/or wireless communication with one or more handheld or electronic devices 220 through respective transceivers 238, 240. The communication may occur through one or more of any desired combination of wired (e.g., cable and fiber) and/or wireless communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, cellular, satellite, microwave, and radio frequency, providing data communication services.

The electronic device 220 may be any one of a variety of computing devices. For example, the electronic device 220 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

In some instances, the electronic device 220 may include one or more processor-based devices, such as a given controller 242 or computing device or any suitable combination of controllers or computing devices. Thus, in several embodiments, the electronic device 220 may include one or more processor(s) 244, and associated memory device(s) 246 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application-specific integrated circuit, and other programmable circuits. Additionally, the memory device(s) 246 of the electronic device 220 may generally comprise memory element(s) including, but not limited to, a computer-readable medium (e.g., random access memory RAM)), a computer-readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 246 may generally be configured to store suitable computer-readable instructions that, when implemented by the processor(s) 244, configure the electronic device 220 to perform various computer-implemented functions, such as one or more aspects of the methods and algorithms that will be described herein. In addition, the electronic device 220 may also include various other suitable components, such as a communications circuit or module, one or more input/output channels, a data/control bus, and/or the like.

It should be appreciated that the various functions of the electronic device 220 may be performed by a single processor-based device or may be distributed across any number of processor-based devices, in which instance such devices may be considered to form part of the electronic device 220. For instance, the functions of the electronic device 220 may be distributed across multiple application-specific controllers, such as a bicycle controller, a sensor controller, and/or the like.

In several embodiments, the memory device 246 may include a database 248 for storing data received from the computing system 216, one or more sensors 251, a user interface 250, and/or from any other source. Moreover, in addition to initial or raw data received from the computing system 216, the one or more sensors 251, the user interface 250, and/or from any other source, final processing data, and/or post-processing data (as well as any intermediate data created during data processing) may also be stored within the database 248.

In various examples, the methods and algorithms of the processor(s) 222 of the computing system 216 and/or the processor(s) 244 of the electronic device 220, can be implemented using a machine learning engine that utilizes one or several machine learning techniques including, for example, decision tree learning, including, for example, random forest or conditional inference trees methods; neural networks; support vector machines; clustering; and Bayesian networks. These algorithms can include computer-executable code that can be retrieved by the memory 224 of the computing system 216, the memory 246 of the electronic device 220, and/or a remote server 260 through a transceiver 261 operably coupled to a network/cloud 262 (FIG. 4) and used to generate a predictive evaluation of the bale characteristics.

In various examples, the processor(s) 222 of the computing system 216, the processor(s) 244 of the electronic device 220, the server, and/or an individual may classify bale characteristics based on various defined features. For example, a user may input a maintenance cost for a vehicle 202 used for a baling operation, fuel costs for a vehicle 202 used for a baling operation, additional supplies (e.g., bale netting) costs for a vehicle 202 used for a baling operation, etc. Additionally or alternatively, in several instances, the various types of bale characteristics could be captured during the use of the management system 200. Each set of data related to the bale characteristics can be manually analyzed to associate each real-world bale characteristics with a cost. That set of the data (the combination of real-world bale characteristics with associated cost) can then be utilized as a set of training data used to train a machine learning engine to perform an automated evaluation of bale characteristics to determine a cost associated with the operation of the vehicle 202. For instance, the machine learning engine may be trained using the set of data by extracting particular features out of the set of data. In response, an estimated cost of operation of the vehicle 202 may be updated or changed based on the received inputs.

As will be described in greater detail below, the electronic device 220 may be configured to communicate with the remote server 260 through a network/cloud 262 (FIG. 4). In such instances, the electronic device 220 may be configured as a dummy device that may provide data to the network and/or receive any instructions, notifications, alerts, and/or suggestions from the cloud 262. As such, in some instances, the electronic device 220 may be free of any one or more of the components provided herein. For example, in some instances, the electronic device 220 may be free of an integrated and/or individual processor(s) 244 and/or memory device(s) 246.

In operation, the work vehicle 202 and/or the baler 204 are configured to form one or more bales of agricultural material. The computing system 216 can be in operative association with the work vehicle 202. The computing system 216 can be configured to determine bale data, such as a number of bales produced, a size of bales being collected (e.g., 4×5, 5×5, or 5×6), number of wraps of net, moisture (provided the baler 204 is equipped with moisture sensor), density setting and if knives are engaged) and/or any other relevant data, as the bale is produced by the work vehicle 202.

The computing system 216 may also receive vehicle data related to the operation of the work vehicle 202 as the one or more bales are formed. The vehicle data can be related to the operation of the work vehicle 202 includes at least one of a distance traveled during the baling operation, an amount of fuel consumed during the baling operation, an amount of wear to one or more components of the work vehicle 202, or an amount of time for the baling operation, and/or any other relevant data. The bale characteristics and/or the vehicle data may be stored in the computing system 216, the electronic device 220, and/or a remote server 260.

The electronic device 220 may be communicatively coupled with the computing system 216. The electronic device 220 can be configured to receive the bale data, which may include the number of bales produced by the work vehicle 202. In addition, the electronic device 220 may be configured to receive the vehicle data. The vehicle data may be provided from the one or more sensors 212 operably coupled with the vehicle 202 and/or a remote server 260. In turn, the electronic device 220 may generate one or more bale characteristics based on the bale data and the vehicle data. In some instances, the one or more bale characteristics includes an estimated cost per bale based on the number of bales and an estimated cost of operation of the work vehicle 202. Additionally or alternatively, the bale characteristics may include a cost per weight of an agricultural product, cost per cubic inch of agricultural product within the bale, etc.

In some instances, the one or more bale characteristics are provided to a user interface 250 of the electronic device 220 and/or the of the vehicle 202. Furthermore, in several embodiments, the vehicle may also include a user interface 250. More specifically, the user interface 250 of the vehicle 202 may be configured to provide feedback and receive inputs from an operator of the vehicle 202. As such, the user interface 250 may include one or more feedback devices, such as display device 218, speakers, warning lights, and/or the like, which are configured to provide feedback from the computing system 216 to the operator. In addition, some embodiments of the user interface 250 may include one or more input devices (not shown), such as touchscreens, keypads, touchpads, knobs, buttons, sliders, switches, mice, microphones, and/or the like, which are configured to receive user inputs from the operator. In various embodiments, the user interface 250 may be mounted or otherwise positioned within the cab of the vehicle 202. However, in alternative embodiments, the user interface 250 may mounted at any other suitable location.

In some instances, the user interface 250 of the electronic device 220 may be configured to provide feedback (e.g., feedback associated with the baling operation) to a user of the management system 200. As such, the user interface 250 may include one or more feedback devices, such as display screens, speakers, warning lights, and/or the like, which are configured to provide feedback from the management system 200 to the operator. In addition, some embodiments of the user interface 250 may include one or more input devices 256, such as keypads, touchpads, knobs, buttons, sliders, switches, mice, microphones, and/or the like, which are configured to receive user inputs from the operator. In some examples, the user interface 250 may include a display 252 having a touchscreen 254. In some embodiments, the user interface 250 may include a user input device in the form of circuitry 258 within the touchscreen 254 to receive an input corresponding with a location over the display 252. In some examples, the electronic device 220 can receive an input related to a desired margin, such as a desired profit margin or loss margin. In response, the management system 200 can generate a suggested bale price based on the estimated cost per bale and the desired margin.

Referring to FIG. 4, in some examples, the electronic device 220 and/or the computing system 216 may be communicatively coupled with one or more remote sites, such as a remote server 260 via a network/cloud 262 to provide data and/or other information therebetween. The network/cloud 262 represents one or more systems by which the electronic device 220 may communicate with the remote server 260. The network/cloud 262 may be one or more of various wired or wireless communication mechanisms, including any desired combination of wired and/or wireless communication mechanisms and any desired network topology (or topologies when multiple communication mechanisms are utilized). Exemplary communication networks 62 include wireless communication networks (e.g., using Bluetooth, IEEE 802.11, etc.), local area networks (LAN) and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 262 in FIG. 4). The verbal image has been formalized in the newer concept of cloud computing. The National Institute of Standards and Technology (NIST) provides a definition of cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not the same, these terms are generally used interchangeably herein, and they may be referred to collectively as the network/cloud 262.

The server 260 may be one or more computer servers, each of which may include at least one processor and at least one memory, the memory storing instructions executable by the processor, including instructions for carrying out various steps and processes. The server 260 may include or be communicatively coupled to a data store 264 for storing collected data as well as instructions for the electronic device 220 and/or the computing system 216 with or without intervention from a user, the electronic device 220, and/or the computing system 216. Moreover, the server 260 may be capable of analyzing initial or raw sensor data received from the one or more electronic devices 220 and final or post-processing data (as well as any intermediate data created during data processing). Accordingly, the instructions provided to any one or more of the electronic devices 220 and/or the computing system 216 may be determined and generated by the server 260 and/or one or more cloud-based applications 266. In such instances, the user interface 250 of the electronic device 220 may be a dummy device that provides various notifications based on instructions from the cloud 262.

With further reference to FIG. 4, the server 260 also generally implements features that may enable the electronic device 220 and/or the computing system 216 to communicate with cloud-based applications 266. Communications from the electronic device 220 can be directed through the network/cloud 262 to the server 260 and/or cloud-based applications 266 with or without a networking device, such as a router and/or modem. Additionally, communications from the cloud-based applications 266, even though these communications may indicate one of the electronic devices 220 as an intended recipient, can also be directed to the server 260. The cloud-based applications 266 are generally any appropriate services or applications 266 that are accessible through any part of the network/cloud 262 and may be capable of interacting with the electronic device 220.

In various examples, the electronic device 220 and/or the computing system 216 can be feature-rich with respect to communication capabilities, i.e. have built-in capabilities to access the network/cloud 262 and any of the cloud-based applications 266 or can be loaded with, or programmed to have, such capabilities. The electronic device 220 and/or the computing system 216 can also access any part of the network/cloud 262 through industry-standard wired or wireless access points, cell phone cells, or network nodes. In some examples, users can register to use the remote server 260 through the electronic device 220 and/or the computing system 216, which may provide access to the electronic device 220 and/or the computing system 216 and/or thereby allow the server 260 to communicate directly or indirectly with the electronic device 220 and/or the computing system 216. In various instances, the electronic device 220 and/or the computing system 216 may also communicate directly, or indirectly, with the electronic device 220 and/or the computing system 216 or one of the cloud-based applications 266 in addition to communicating with or through the server 260. According to some examples, the electronic device 220 and/or the computing system 216 can be preconfigured at the time of manufacture with a communication address (e.g. a URL, an IP address, etc.) for communicating with the server 260 and may or may not have the ability to upgrade or change or add to the preconfigured communication address.

Referring still to FIG. 4, when a new cloud-based application 266 is developed and introduced, the server 260 can be upgraded to be able to receive communications for the new cloud-based application 266 and to translate communications between the new protocol and the protocol used by the electronic device 220 and/or the computing system 216. The flexibility, scalability, and upgradeability of current server technology render the task of adding new cloud-based application protocols to the server 260 relatively quick and easy.

In several embodiments, an application interface 268 may be operably coupled with the cloud 262 and/or the application 266. The application interface 268 may be configured to receive data related to one or more vehicles 202 that may be involved in the bale generation process (e.g., a seeder, planter, sprayer, harvester, baler, windrower, etc.) and/or data related to bale data, such as a number of bales produced, a size of bales being collected (e.g., 4×5, 5×5, or 5×6), number of wraps of net, moisture (provided the baler 204 is equipped with moisture sensor), density setting and if knives are engaged) and/or any other relevant data, as the bale is produced by the work vehicle 202.

In various embodiments, one or more inputs related to the vehicle data and/or the bale data may be provided to the application interface 268. For example, a farmer, a vehicle user, a company, or other persons may access the application interface 268 to enter the inputs related to the vehicle data and/or the bale data. Additionally or alternatively, the inputs related to the vehicle data and/or the bale data may be received from a remote server 260. For example, the inputs related to the vehicle data and/or the bale data may be received in the form of software that can include one or more objects, agents, lines of code, threads, subroutines, databases, application programming interfaces (APIs), or other suitable data structures, source code (human-readable), object code (machine-readable). In response, the management system 200 may update any input/output based on the received inputs. The application interface 268 can be implemented in hardware, software, or a suitable combination of hardware and software, and which can be one or more software systems operating on a general-purpose processor platform, a digital signal processor platform, or other suitable processors.

In some examples, at various predefined periods and/or times, the electronic device 220 and/or the computing system 216 may communicate with the server 260 through the network/cloud 262 to obtain the stored instructions, if any exist. Upon receiving the stored instructions, the electronic device 220 and/or the computing system 216 may implement the instructions. The server 260 may additionally store information related to multiple vehicles 202 and/or baling operations that are performed on a common field, proximate fields, and/or any other location and operate and/or provide instructions to the electronic devices 220 and/or the computing system 216 in conjunction with the stored information with or without intervention from a user, the electronic device 220, and/or the computing system 216. For example, any number of vehicles 202 each having a computing system 216 and users can access the server 260 for storing and retrieving event-related data. In some instances, multiple electronic devices 220 on multiple vehicles 202 can send event-related data to the server 260 for storage in the data store 264. This collection of event-related data can be accessed by any number of users, electronic devices 220, and/or computing systems 216 to assist with generation of one or more bale characteristics.

In some instances, a computing device 270 may also access the server 260 to obtain information related to stored events. The computing device 270 may be a mobile device, tablet computer, laptop computer, desktop computer, watch, virtual reality device, television, monitor, or any other computing device 270 or another visual device. In some instances, the computing device 270 may be used to provide an invoice, and/or any other information, to a third party.

In various embodiments, the data used by the management system 200, the electronic device 220 within the management system 200, the remote server 260, the data store 264, the application 266, the application interface 268, the computing device 270, and/or any other component described herein for any purpose may be based on data provided by the one or more sensors 212 operably coupled with the one or more vehicles 202 and/or third-party data that may be converted into comparable data that may be used independently or in conjunction with data collected from the one or more sensors 212.

In various examples, the server may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the server 260 through the network/cloud 262 and may be used to generate a predictive evaluation of the bale characteristics. In some instances, the machine learning engine may allow for changes to the bale characteristics (e.g., price per bale) to be performed without human intervention.

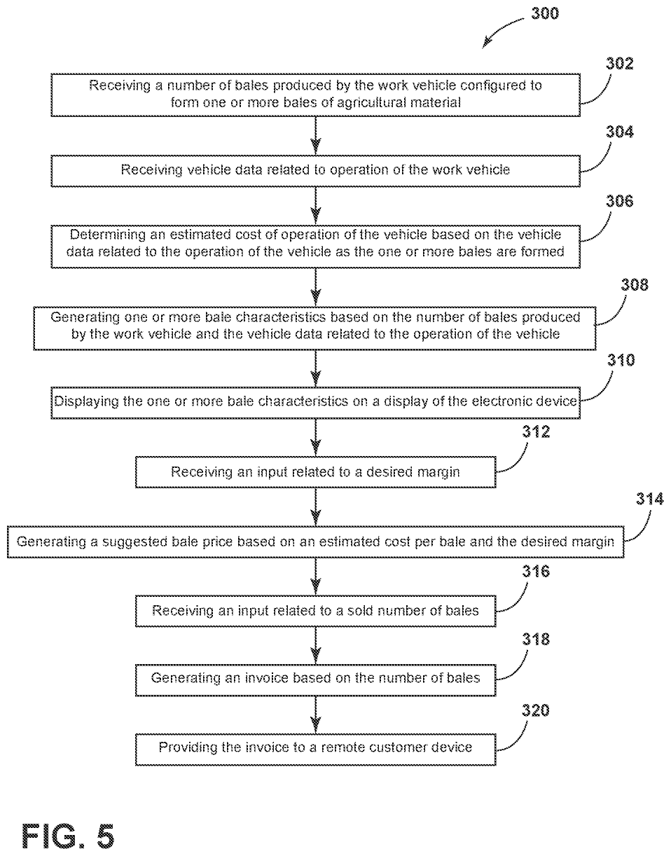

Referring now to FIG. 5, a flow diagram of some embodiments of a method 300 for performing a baling operation with a management system is illustrated in accordance with aspects of the present subject matter. In general, the method 300 will be described herein with reference to the vehicle and the management system 200 described above with reference to FIGS. 1-4. However, it will be appreciated by those of ordinary skill in the art that the disclosed method 300 may generally be utilized with any suitable agricultural vehicle and/or may be utilized in connection with a system having any other suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 includes receiving a number of bales produced by the work vehicle configured to form one or more bales of agricultural material. In some instances, the computing system may detect and store the number of bales formed during the baling operation. Additionally or alternatively, the computing system may receive an input from a user indicating the formation of the bale. In addition to storing the number of bales, the computing system may also receive, detect, and/or store other bale data.

At (304), the method 300 includes receiving vehicle data related to the operation of the work vehicle. In some instances, the vehicle data may be generated as the one or more bales are formed. Additionally or alternatively, the method 300 may also receive data from the vehicle prior to and after the formation of the bales. Additionally or alternatively, the method 300 may also include receiving vehicle data related to additional vehicles that may be used during the formation process of the agricultural product. In various embodiments, the vehicle data related to the operation of the work vehicle can include at least one of a distance traveled during the baling operation, an amount of fuel consumed during the baling operation, an amount of wear to one or more components of the work vehicle, or an amount of time for the baling operation.

At (306), the method 300 includes determining an estimated cost of operation of the vehicle based on the vehicle data related to the operation of the vehicle.

At (308), the method 300 can include generating one or more bale characteristics based on the number of bales produced by the work vehicle and the vehicle data related to the operation of the vehicle. In some instances, the vehicle data and the bale data may both be received by an electronic device. In turn, the electronic device may generate the one or more bale characteristics. Additionally or alternatively, the vehicle data and the bale data may both be received by a remote server. In turn, the remote server may generate the one or more bale characteristics that may then be provided to the computing system of the vehicle and/or a remote electronic device.

In some instances, the one or more bale characteristics can include an estimated cost per bale based on the estimated cost of operation of the vehicle. Additionally or alternatively, the bale characteristics may include a cost per weight of an agricultural product, cost per cubic inch of agricultural product within the bale, etc.

At (310), the method 300 can include displaying the one or more bale characteristics on a display of the electronic device. Additionally or alternatively, the one or more bale characteristics may be displayed on the computing system of the vehicle.

At (312), the method 300 can include receiving an input related to a desired margin, such as a desired profit margin or loss margin, through an interface of the electronic device. In response, at (314), the method 300 can include generating a suggested bale price based on an estimated cost per bale and the desired margin.

At (316), the method 300 can include receiving an input related to a sold number of bales. At (318), the method 300 can include generating an invoice based on the number of bales. Once generated, at (320), the method 300 can include providing or transmitting the invoice to a remote computing device.

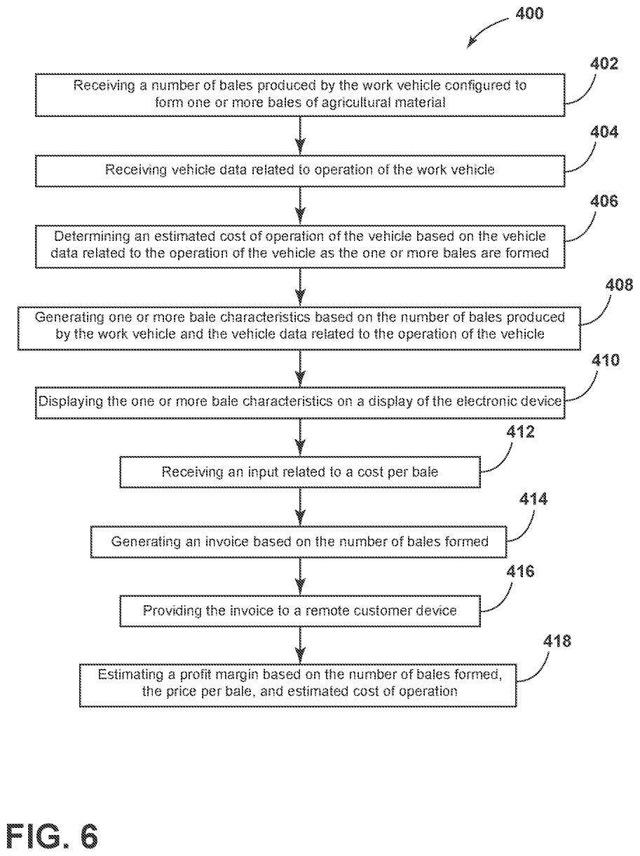

Referring now to FIG. 6, a flow diagram of some embodiments of a method 400 for performing a baling operation with a management system is illustrated in accordance with aspects of the present subject matter. In general, the method 400 will be described herein with reference to the vehicle and the management system 200 described above with reference to FIGS. 1-4. However, it will be appreciated by those of ordinary skill in the art that the disclosed method 400 may generally be utilized with any suitable agricultural vehicle and/or may be utilized in connection with a system having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (402), the method 400 includes the method 400 includes receiving a number of bales produced by the work vehicle configured to form one or more bales of agricultural material. In some instances, the computing system may detect and store the number of bales formed during the baling operation. Additionally or alternatively, the computing system may receive an input from a user indicating the formation of the bale. In addition to storing the number of bales, the computing system may also receive, detect, and/or store other bale data.

At (404), the method 400 includes receiving vehicle data related to the operation of the work vehicle. In some instances, the vehicle data may be generated as the one or more bales are formed. Additionally or alternatively, the method 400 may also receive data from the vehicle prior to and after the formation of the bales. Additionally or alternatively, the method 400 may also include receiving vehicle data related to additional vehicles that may be used during the formation process of the agricultural product. In various embodiments, the vehicle data related to the operation of the work vehicle can include at least one of a distance traveled during the baling operation, an amount of fuel consumed during the baling operation, an amount of wear to one or more components of the work vehicle, or an amount of time for the baling operation.

At (406), the method 400 includes determining an estimated cost of operation of the vehicle based on the vehicle data related to the operation of the vehicle.

At (408), the method 400 can include generating one or more bale characteristics based on the number of bales produced by the work vehicle and the vehicle data related to the operation of the vehicle. In some instances, the vehicle data and the bale data may both be received by an electronic device. In turn, the electronic device may generate the one or more bale characteristics. Additionally or alternatively, the vehicle data and the bale data may both be received by a remote server. In turn, the remote server may generate the one or more bale characteristics that may then be provided to the computing system of the vehicle and/or a remote electronic device.

In some instances, the one or more bale characteristics can include an estimated cost per bale based on the estimated cost of operation of the vehicle. Additionally or alternatively, the bale characteristics may include a cost per weight of an agricultural product, price per cubic inch of the bale, etc.

At (410), the method 400 can include displaying the one or more bale characteristics on a display of the electronic device. Additionally or alternatively, the one or more bale characteristics may be displayed on the computing system of the vehicle.

At (412), the method 400 can include receiving an input related to a cost per bale through an interface of the electronic device. At (414), the method 400 can include generating an invoice based on the number of bales and the inputted cost per bale. Once generated, at (416), the method 400 can include providing the invoice to a remote computing device. In addition, at (418), the method 400 can include estimating a profit margin based on the number of bales formed, the price per bale, and/or estimated cost of operation, which may be provided to the electronic device.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A management system for a baling operation, the system comprising:
a vehicle configured to form one or more bales of agricultural material;
a computing system provided in operative association with the vehicle, the computing system configured to determine bale data including at least a number of bales produced by the vehicle and receive, from one or more sensors, vehicle data related to operation of the vehicle as the one or more bales are formed; and
an electronic device communicatively coupled with the computing system, the electronic device including a processor and associated memory, the memory storing instructions that, when implemented by the processor, configure the electronic device to:
receive the number of bales produced by the vehicle;
receive the vehicle data related to the operation of the vehicle as the one or more bales are formed;
generate one or more bale characteristics based on the number of bales produced by the vehicle and the vehicle data related to the operation of the vehicle as the one or more bales are formed, wherein the one or more bale characteristics includes an estimated cost per bale based on the estimated cost of operation of the vehicle;
receive an input related to a desired margin through a user interface;
generate a suggested bale price based on the estimated cost per bale and the desired margin;
receive an input related to a sold number of bales;
generate an invoice based on the sold number of bales and the desired margin; and
provide the invoice to a remote computing device.

2. The management system of claim 1, wherein the electronic device is further configured to determine an estimated cost of operation of the vehicle based on the vehicle data related to the operation of the vehicle as the one or more bales are formed.

3. (canceled)

4. The management system of claim 31, wherein the electronic device is further configured to display the one or more bale characteristics.

5. (canceled)

6. The management system of claim 1, wherein the electronic device is further configured to:
receive an input related to a sold number of bales;
generate an invoice based on the sold number of bales; and
provide the invoice to a remote computing device.

7. The management system of claim 1, wherein the vehicle data related to operation of the vehicle includes at least one of a distance traveled during the baling operation, an amount of fuel consumed during the baling operation, an amount of wear to one or more components of the vehicle, or an amount of time for the baling operation.

8. A method for performing a baling operation, the method comprising:
forming one or more bales of agricultural material with a vehicle;
receiving, from a computing system operably coupled with the vehicle, a number of bales produced by the vehicle;
receiving, from the computing system, vehicle data related to operation of the vehicle as the number of bales formed;
generating, through an electronic device, one or more bale characteristics based on the number of bales produced by the vehicle and the vehicle data related to the operation of the vehicle as the one or more bales are formed;
determining an estimated cost of operation of the vehicle based on the vehicle data related to the operation of the vehicle as the one or more bales are formed;
displaying the one or more bale characteristics on a display of the electronic device;
receiving, through an interface of the electronic device, an input related to a desired margin;
generating a suggested bale price based on an estimated cost per bale and the desired margin; and
transmitting the invoice to a computing device remote from the electronic device and the computing system.

9. (canceled)

10. The method of claim 9, wherein the vehicle data related to operation of the vehicle includes at least one of a distance traveled during the baling operation, an amount of fuel consumed during the baling operation, an amount of wear to one or more components of the vehicle, or an amount of time for the baling operation.

11. The method of claim 8, wherein the one or more bale characteristics includes an estimated cost per bale based on an estimated cost of operation of the vehicle.

12. (canceled)

13. The method of claim 12, wherein the estimated cost per bale is calculated based on the vehicle data related to operation of the vehicle as the number of bales formed.

14. The method of claim 8, further comprising:
receiving an input related to a sold number of bales;
determining a price per bale based on a second input received through an interface of the electronic device;
generating an invoice based on the number of bales; and
providing the invoice to a remote computing device.

15. The method of claim 8, wherein the one or more bale characteristics includes at least one of an estimated cost per bale based on the number of bales and an estimated cost of operation of the vehicle, a cost per weight of an agricultural product, or cost per cubic inch of agricultural product within the bale.

16. A management system for a baling operation, the system comprising:
a vehicle configured to form one or more bales of agricultural material;
a computing system provided in operative association with a vehicle, the computing system configured to determine a number of bales produced by the vehicle and receive vehicle data related to operation of the vehicle as one or more bales are formed; and
an electronic device communicatively coupled with the computing system, the electronic device including a processor and associated memory, the memory storing instructions that, when implemented by the processor, configure the electronic device to:
receive the number of bales and the vehicle data from the computing system;
receive, through a user interface of the electronic device, an input related to a cost per bale; and
generate, through the electronic device, one or more bale characteristics based on the number of bales produced by the vehicle and the vehicle data related to the operation of the vehicle as the one or more bales are formed using one or more machine learning engines;
receive, through an interface of the electronic device, an input related to a desired margin;
generate an invoice based on an estimated cost per bale and the desired margin, wherein the invoice is transmitted to a computing device, the computing system, the electronic device, and the computing device being remote from one another.

17. The management system of claim 16, wherein the electronic device is further configured to determine an estimated cost of operation of the vehicle as the one or more bales are formed.

18. The management system of claim 16, wherein the electronic device is further configured to generate and transmit a profit margin to the electronic device, the electronic device remote from the computing device.

19. The management system of claim 16, wherein the vehicle data related to operation of the vehicle includes at least one of a distance traveled during the baling operation, an amount of fuel consumed during the baling operation, an amount of wear to one or more components of the vehicle, or an amount of time for the baling operation.

20. The management system of claim 16, wherein the electronic device is further configured to:
receive an input related to a sold number of bales;
generate an invoice based on the sold number of bales; and
provide the invoice to the computing device.
